(19) United States
(12) Patent Application Publication
(10) Pub. No.: US 2021/0026587 A1
(43) Pub. Date: Jan. 28, 2021

(54) TOUCH APPARATUS

(71) Applicant: FlatFrog Laboratories AB, Lund (SE)

(72) Inventors: Tomas CHRISTIANSSON, Torna-Hallestad (SE); Örjan FRIBERG, Lund (SE); Pablo CASES, Lomma (SE)

(21) Appl. No.: 16/982,484

(22) PCT Filed: Apr. 13, 2019
(86) PCT No.: PCT/SE2019/050343

§ 371 Date: Sep. 18, 2020

(30) Foreign Application Priority Data
Apr. 19, 2018 (SE) 1830133-3

(51) Int. Cl. G06F 3/147; G06F 3/041; H04L 29/08; G06F 3/044; G06F 3/045; G06F 3/042; G06F 3/043

(52) U.S. Cl. CPC G06F 3/147; G06F 3/0416; H04L 29/0899; G06F 3/043; G06F 3/045; G06F 3/042; G06F 3/044

(57) ABSTRACT

A system is provided for processing touch data. The system comprises an operating system having a user interface and being configured to process touch data according to a first protocol and a software application running on the operating system. The software application provides an interaction area on the user interface and being configured to process touch data according to a second protocol. A touch controller is configured to send a first touch data corresponding to a touch event to the operating system via a first channel and a second touch data corresponding to the touch event to the software application via a second channel. Where the first touch data corresponds to the interaction area on the user interface, the operating system communicates the first touch data to the software application. Subsequently, where the first touch data received from the operating system corresponds to the second touch data received from the touch controller, the software application processes the first and/or second touch data according to a second protocol.

The present invention relates to an improved touch experience on touch surfaces of touch-sensitive apparatus. In particular, the present invention relates to handling application specific touch controls.

Touch-sensitive systems (“touch systems”) are in widespread use in a variety of applications. Typically, the touch systems are configured to detect a touching object such as a finger or stylus, either in direct contact, or through proximity (i.e. without contact), with a touch surface. Touch systems may be used as touch pads in laptop computers, equipment control panels, and as overlays on displays e.g. hand-held devices, such as mobile telephones. A touch panel that is overlaid on or integrated in a display is also denoted a “touch screen”. Many other applications are known in the art.

There are numerous known techniques for providing touch sensitivity, e.g. by incorporating resistive wire grids, capacitive sensors, strain gauges, etc. into a touch panel. There are also various types of optical touch systems, which e.g. detect attenuation of emitted light by touch objects on or proximal to a touch surface.

One specific type of optical touch system uses projection measurements of light that propagates on a plurality of propagation paths inside a light transmissive panel. The projection measurements thus quantify a property, e.g. power, of the light on the individual propagation paths, when the light has passed the panel. For touch detection, the projection measurements may be processed by simple triangulation, or by more advanced image reconstruction techniques that generate a two-dimensional distribution of disturbances on the touch surface, i.e. an “image” of everything on the touch surface that affects the measured property. The light propagates by total internal reflection (TIR) inside the panel such that a touching object causes the propagating light on one or more propagation paths to be attenuated by so-called frustrated total internal reflection (FTIR). Hence, this type of system is an FTIR-based projection-type touch system. Examples of such touch systems are found in U.S. Pat. Nos. 3,673,327, 4,254,333, 6,972,753, US2004/0252091, US2006/0114237, US2007/0075648, WO2009/048365, US2009/0153519, US2017/0344185, WO2010/006882, WO2010/064983, and WO2010/134865.

Another category of touch sensitive apparatus is known as projected capacitive (“p-cap”). A set of electrodes are spatially separated in two layers usually arranged in rows and columns. A controller scans and measures the capacitance at each row and column electrode intersection. The intersection of each row and column produces a unique touch-coordinate pair and the controller measures each intersection individually. An object that touches the touch surface will modify the capacitance at a row and column electrode intersection. The controller detects the change in capacitance to determine the location of the object touching the screen.

In another category of touch-sensitive apparatus known as ‘above surface optical touch systems’, a set of optical emitters are arranged around the periphery of a touch surface to emit light that travels above the touch surface. A set of light detectors are also arranged around the periphery of the touch surface to receive light from the set of emitters from above the touch surface. An object that touches the touch surface will attenuate the light on one or more propagation paths of the light and cause a change in the light received by one or more of the detectors. The location (coordinates), shape or area of the object may be determined by analysing the received light at the detectors. Examples of such touch systems are found in e.g. PCT/SE2017/051233 and PCT/EP2018/052757.

FIG. 1 shows a schematic representation of a touch system 110. The touch system 110 comprises the touch-sensitive apparatus 110, touch controller 120, host device 130, host operating system 140, USB HID driver 150, software application 160, and display device 180. The display device 180 is configured to display the output from the host device 130. The host device 130 receives touch data, including touch co-ordinates, from touch controller 120. The operating system 140 of host device 130 processes the touch data using USB HID driver 150. Where the touch co-ordinates of the touch data correspond to a position on the operating system user interface occupied by a software application, the processed touch data is passed to the software application. Once the application has determined how to process the touch data and display the output, the results are passed to the display device via the operating system.

When using the touch system of FIG. 1, standard drawing can suffer from total system latency which results in a visual lag on a display device coupled to the host device. Latency can be introduced from the touch-sensing apparatus, the host device or the display device. One solution is for the host device to control the display device to reduce the perceived total system latency. Such a system (e.g. Windows Ink) temporarily displays a predicted touch trace (also known as “evanescent predictions”) based on human interface device (HID) input. The predicted touch trace is drawn before the confirmed touch trace and in this way the user perceives a reduced latency total system latency. The predicted touch trace is then redrawn each frame. In FIG. 1, the processing to provide the reduction of perceived total system latency may be processed by the operating in the USB HID driver 150.

A problem with using a USB HID API of an operating system for transmitting touch data (e.g. as described above) is that it the operating system's configuration for processing the USB HID data is usually standardised and fixed according to the USB HID standard. Extra features such as touch prediction and touch smoothing need to be offered on top of the USB HID standard, where they are applied universally within the operating system and typically cannot be altered, updated, or improved by a user. Where new types of touch sensors and touch controllers offering more advanced features are deployed to the operating system, these features may be unavailable if unsuitable for use through the USB HID API. For example, if the predictive feature provided by the operating system is unsuitable or performs badly with a particular type of touch system, typically, the only option is to disable it. Furthermore, if the touch system is used with a different operating system, the predictive/smoothing features of the new operating system may or may not be the same as the other system and so the touch system may behave inconsistently.

What is needed is a method of allowing application level control of touch features such as predictive touch, touch smoothing, and other features that a touch system provide may wish to optimise. This would allow a touch system developer to control the touch experience at an application level independently from the operating system's touch processing.

One solution is to send touch data from touch controller 120 on a private channel to one or more applications 160 running on the operating system 140. If the touch co-ordinates correspond to a position on the operating system user interface occupied by one of the applications, the respective application receives and processes the touch data directly. If the touch co-ordinates do not correspond to a position on the operating system user interface occupied by one of the applications, the processed touch data is passed back to the touch controller and re-sent to the operating system via the USB HID channel.

This solution has several problems. Multiple overlapping application windows can result in the same touch data being passed back and resent multiple times leading to multiple inputs over the USB HID channel. Passing back and resending the touch data also adds significant latency to the touch inputs. Furthermore, certain operating system level gestures may be ignored and misinterpreted by this system. For example, an edge swipe gesture usually recognised by the operating system may instead be incorrectly interpreted as application input where the gesture passes into an application window of a listening application.

Therefore, what is needed is a way to communicate touch data to an application that is transparent to and compatible with the operating system and can work on all operating systems, allowing the application to use an application framework of choice for user interface interaction, and that does not suffer from the problems described above.

### SUMMARY OF THE INVENTION

Embodiments of the present invention aim to address the aforementioned problems.

According to a first aspect of the present invention there is a system for processing touch data, the system comprising: an operating system having a user interface and being configured to process touch data according to a first protocol; a software application running on the operating system, the software application providing an application window on the user interface and being configured to process touch data according to a second protocol; a touch controller configured to send a first touch data corresponding to a touch event to the operating system via a first channel and a second touch data corresponding to the touch event to the software application via a second channel; the operating system being configured such that, where the first touch data corresponds to the application window of the software application on the user interface, the operating system communicates the first touch data to the software application, the software application being configured such that, where the first touch data received from the operating system corresponds to the second touch data received from the touch controller, the software application processing the first and/or second touch data according to a second protocol.

According to a second aspect of the present invention there is a method for processing touch data in a touch system, the touch system comprising: an operating system having a user interface and being configured to process touch data according to a first protocol; a software application running on the operating system, the software application providing an application window on the user interface and being configured to process touch data according to a second protocol; the method comprising the steps of: receiving a first touch data corresponding to a touch event at the operating system via a first channel and a second touch data corresponding to the touch event at the software application via a second channel; determining if the first touch data corresponds to the application window on the user interface, where the first touch data corresponds to the application window, communicating the first touch data to the software application, determining if the first touch data received by the software application corresponds to the second touch data received from the touch controller, where the first touch data received by the software application corresponds to the second touch data received from the touch controller, processing the first and/or second touch data according to a second protocol.

### FIGURES

Various other aspects and further embodiments are also described in the following detailed description and in the attached claims with reference to the accompanying drawings, in which:

FIG. 1 shows a schematic representation of a touch system;

FIG. 2 shows a user interface of an operating system;

FIG. 3 shows a schematic representation of a touch system;

FIG. 4 shows a touch data processing flow chart for a touch system;

FIG. 5 shows a latency timing diagram of a touch system;

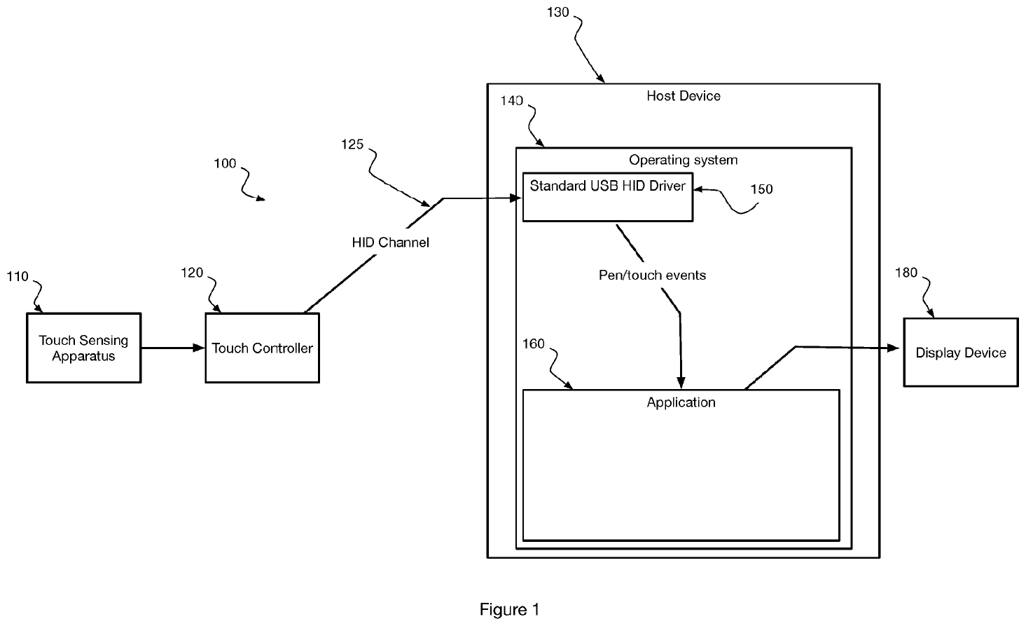

### DESCRIPTION

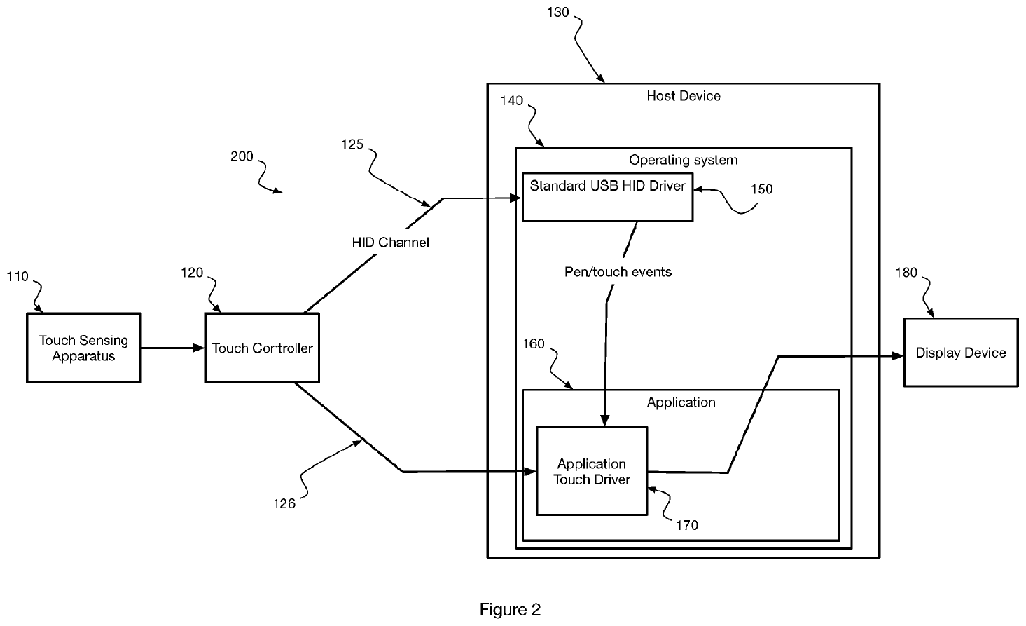

FIG. 2 shows a schematic representation of a touch system 200. The touch system 200 comprises the touch-sensitive apparatus 110, touch controller 120, host device 130, host operating system 140, USB HID driver 150, software application 160, touch driver 170 and display device 180.

The touch-sensitive apparatus 110 may comprise any one of the touch-sensitive apparatus described above. E.g. FTIR, resistive, surface acoustic wave, capacitive, surface capacitance, projected capacitance, above surface optical touch, dispersive signal technology and acoustic pulse recognition type touch systems. The touch-sensitive apparatus 110 can be any suitable apparatus for detecting touch input from a human interface device. The touch-sensitive apparatus 110 detects a touch object when a physical object is brought in sufficient proximity to, a touch surface so as to be detected by one or more sensors in the touch-sensitive apparatus. The touch-sensitive apparatus 110 is configured to output a touch signal which is received and processed by touch controller 120.

In one embodiment, touch controller 120 is configured to receive a touch signal from touch sensing apparatus 110 and processes the touch signal to generate touch data for host device 130 in dependence on the touch signal. The touch data comprises data about touches detected from the touch signal, including touch co-ordinates. The touch data may also contain touch meta-data such as touch pressure, object type, etc. The touch controller 120 may include one or more processing units, e.g. a CPU (“Central Processing Unit”), a DSP (“Digital Signal Processor”), an ASIC (“Application-Specific Integrated Circuit”), discrete analogue and/or digital components, or some other programmable logical device, such as an FPGA (“Field Programmable Gate Array”). The touch controller 120 may further include a system memory and a system bus that couples various system components including the system memory to the processing unit. The system bus may be any of several types of bus structures including a memory bus or memory controller, a peripheral bus, and a local bus using any of a variety of bus architectures. The system memory may include computer storage media in the form of volatile and/or non-volatile memory such as read only memory (ROM), random access memory (RAM) and flash memory. The special-purpose software and associated control parameter values may be stored in the system memory, or on other removable/non-removable volatile/non-volatile computer storage media which is included in or accessible to the computing device, such as magnetic media, optical media, flash memory cards, digital tape, solid state RAM, solid state ROM, etc. The special-purpose software may be provided to the processing unit 120 on any suitable computer-readable medium, including a record medium, and a read-only memory. In some embodiments, the touch-sensitive apparatus 110 and touch controller 120 form a single component.

The host device 130 may comprise one or more processing units, a system memory, and a system bus that couples various system components including the system memory to the processing unit. The system bus may be any of several types of bus structures including a memory bus or memory controller, a peripheral bus, and a local bus using any of a variety of bus architectures. The system memory may include computer storage media in the form of volatile and/or non-volatile memory such as read only memory (ROM), random access memory (RAM) and flash memory. The host device 130 is connectively coupled to the touch controller 120 and receives touch data, including touch co-ordinates, from touch controller 120. The host device 130 and the touch controller 120 are connectively coupled via first channel 125 and second channel 126. Channels 125 and 126 may be provided over wired data connections such as USB, ethernet, firewire, etc or wireless data connections such as Wi-Fi, Bluetooth, etc. In some embodiments there can be a plurality of data connections between the host device 130 and the touch controller 120 for transmitting different channels. In preferred embodiments, first channel 125 is a human interface device (HID) USB channel.

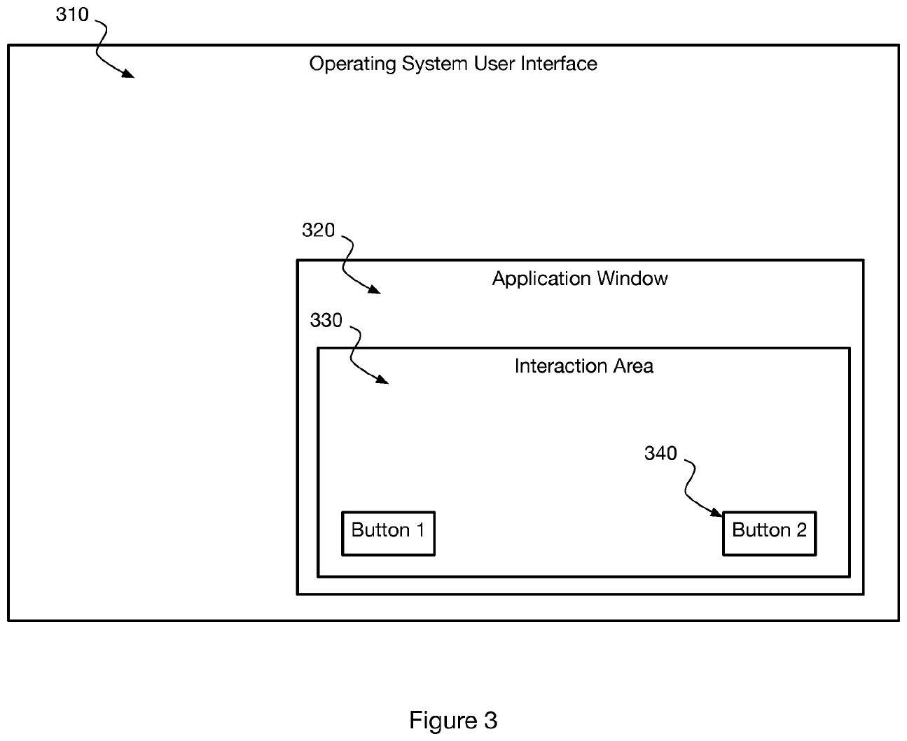

The host device 130 comprises an operating system 140 and one or more applications 160 that run on the operating system 140. As shown in FIG. 3, the one or more applications 160 are configured to show an application window 320 interaction area on the operating system user interface 310. The application window comprises an interaction area 330 to receive touch interaction and allow the user to interact with touch system 200. Interaction area 330 may comprise a portion or the entirety of application window 320. The operating system 140 is configured to display the operating system user interface 310 on display device 180. The applications 160 may be drawing applications or whiteboards applications for visualising user input. In other embodiments the applications 160 can be any suitable application or software for receiving and displaying user input. The application 160 can send instructions or data for graphical representation of the determined touch interaction with interaction area 330 to the display device 180 via the operating system. Accordingly, the user input is displayed on the display device 180 in the format required by the application 160.

In embodiments of the invention, one or more applications may be running on the operating system, each application may have one or more application windows, and each application window may comprise one or more interaction areas. Each interaction area may be configured to receive the second touch data.

In one embodiment in which the application window comprises user interface elements 340, the interface elements 340 are provided by the application framework 465 and can be overlaid over the interaction area. In this embodiment, the application can be configured to allow access to the user interface elements without making use of the second touch data for interpreting the touch interaction in the interaction area. The user interface elements may include typical user interface elements such as buttons, menus, sliders, etc. Preferably, the application determines whether to make use of the second touch data for interpreting the touch interaction only at the start of a touch trace and not continuously. This way, a touch interaction that is to be processed by the application using the second touch data but that briefly passes through a UI element is not disrupted. Likewise, for a touch interaction that starts on a UI element, it is not processed using the second touch data where the touch interaction passes across a portion of an interaction area.

Returning to FIG. 2, in one embodiment, the operating system 140 processes touch data received touch controller 120 via first channel 125 using USB HID driver 150. USB HID driver 150 is a process that forms part of operating system 130 and is configured to listen on first channel 125. In other embodiments, the touch data received through first channel 125 may be processed by standard or proprietary protocols other than standard USB HID.

Where the touch co-ordinates of the touch data correspond to a position on the operating system user interface occupied by an application, the processed touch data is passed to the application. Once the application has determined how to process the touch data and display the output, the results are passed to the display device via the operating system.

The display device 180 is configured to display the output from the host device 130. The display device 180 can be any suitable device for visual output for a user such as a monitor. The display device 180 is controlled by a display controller 206. Display devices 180 and display controllers 206 are known and will not be discussed in any further depth for the purposes of expediency.

In some embodiments the touch-sensitive apparatus 110, the host device 130 and the display device 180 are integrated into the same device such as a laptop, tablet, smart phone, monitor or screen. In other embodiments, the touch-sensitive apparatus 110, the host device 130 and the display device 180 are separate components. For example, the touch-sensitive apparatus 110 can be a separate component mountable on a display screen.

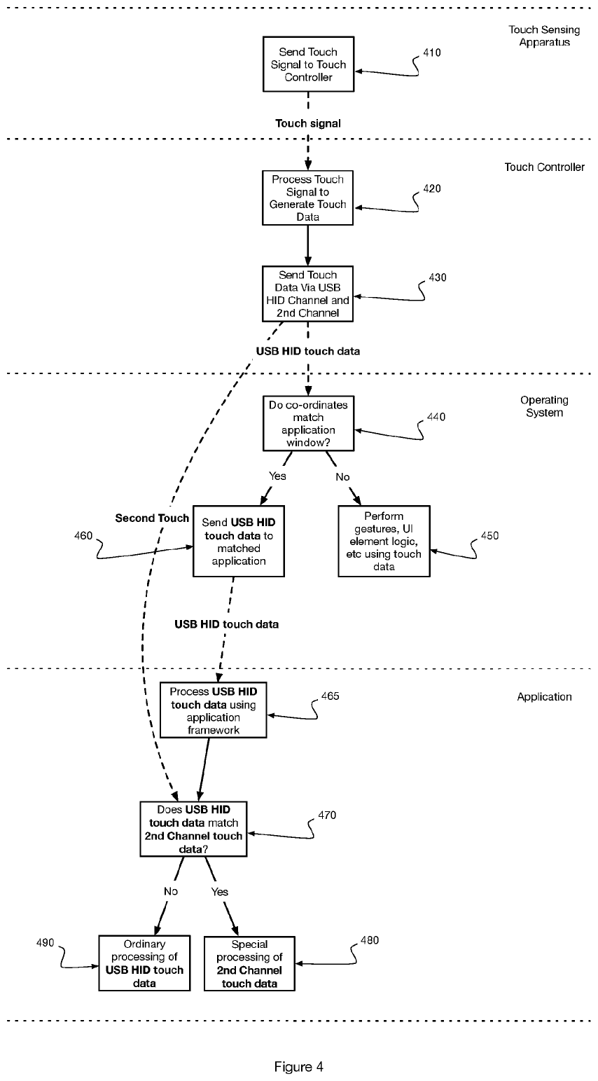

FIG. 4 shows a process flow for an embodiment of the invention. In step 410, touch sensing apparatus 110 transmit the touch signal to touch controller 120.

Preferably, the touch sensing apparatus 110 generates a touch signal in a sequence of frames indicative of touch interaction with the touch sensing apparatus during each frame. In step 420, touch controller 120 receives and processes the touch signal to generate touch data. The touch data generated by the touch controller may be generated in a corresponding set of frames. Preferably, the touch data generated by the touch controller for each frame describes the position of any touching objects detected by the touch sensing apparatus during the respective frame. The touch data may also include meta-data associated with the respective touching objects. e.g. device lift up indication, pressure, speed, direction, predicted position, low latency position, shape, type of touching device, orientation of touching device, and/or angle of touching device.

In step 430, the touch controller sends at least a first portion of the generated touch data (first touch data) to the operating system via the first channel 125. In a preferred embodiment, the first touch data is sent to the operating system via the USB HID API. The USB HID API is a standard interface and is available on at least Windows®, Linux®, Android®, or MacOS®. At the same time, the touch controller sends at least a second portion of the generated touch data via the second channel 126. Where the operating system is Windows®, Linux®, Android®, or MacOS®, the touch controller sends at least a second portion of the generated touch data (second touch data) to a selected port. This second touch data is then received by any applications listening on the selected port.

In step 440, the operating system processes the first touch data via the USB HID API and determines the touch co-ordinates in the first touch data. The operating system determines whether the touch co-ordinates falls within an application window 320, or otherwise within the area defined by the operating system user interface 310. Where the operating system determines that the touch co-ordinates of the first touch data do not match an application, the touch data is processed normally according to the operating system's gesture processing protocol, as per step 450. This may include the normal processing of touch gestures, such as edge swipes. In alternative embodiments, the touch data is processed according to the operating system's gesture processing protocol (I.e. operating system's standard protocol) first, and then, where no gesture is recognised, the touch data is passed to a matching application. Where the operating system determines that the touch co-ordinates of the first touch data do fall within an area of the operating system user interface 310 defined by an interaction area 330, the touch data is not processed by the operating system and is sent to the application to which the interaction area 330 belongs, as per step 460. Preferably, the operating systems determines whether to send the touch data to the application only at the start of a touch trace and not continuously. i.e. the operating systems determines whether to send the touch data to the application only each time the user newly makes contact with the touch surface. This way, a touch interaction that is to be processed by the operating system but that briefly passes through the interaction area is not captured by the application. i.e. an edge swipe may safely be performed even close to an interaction area.

In step 470, the software application receives either just the second touch data from the touch controller or both the second touch data and the first touch data from the operating system. Where the software application receives just the second touch data, the application takes no further action to process the second touch data. However, where the software application receives both the second touch data and the first touch data, the software application compares the first and second touch data to determine if they correspond to the same touch event. The first and second touch data may be determined to be corresponding where they each describe a touch trace having substantially the same position at substantially the same time. Alternatively, other methods of determining that the first and second touch data correspond to the same touch event may be used, including use of unique touch ID. In step 480, where the first and second data correspond to the same touch event (i.e. they were created by the touch controller to describe the same touch frame or touch event) and the first touch data coordinates fall within the interaction area of the application, the application is configured to process the touch data of the first and second touch data according to its own protocol. i.e. The application is not limited to using the operating system's standard protocol for processing the touch data and may enable more advanced features. In one embodiment, features enabling predictive touch, as described in SE 1830079-8, may be enabled using the second touch data to provide the first touch data with lower latency predictive touch tracing. In other embodiments, the second touch data may be used to provide touch smoothing, improved touch accuracy, or other features that are difficult or impossible to implement using the operating system's standard protocol alone. All processing of touch data by application 160 may be performed by the application or by application touch driver 170.

In an alternative embodiment, the second touch data reaches the application 160 via the first channel. Upon arrival at the operating system, the second touch data is identified as vendor specific touch data and not processed by the Standard USB HID Driver. Instead, the second touch data is made available to any application that is listening for the second touch data. In this embodiment, the second channel may be interpreted as the channel between the operating system and the application for transmitting unprocessed second touch data.

In step 490, where the first and second data do not correspond to the same touch event, the application is configured to process the touch data of the first and second touch data according to another protocol. This may be the operating system's standard protocol or another protocol designed to provide intermediate features that cannot benefit from the second touch data but that provide a different outcome than the operating system's standard protocol.

In another embodiment two or more embodiments are combined. Features of one embodiment can be combined with features of other embodiments.

Embodiments of the present invention have been discussed with particular reference to the examples illustrated. However, it will be appreciated that variations and modifications may be made to the examples described within the scope of the invention.

1. A system for processing touch data, the system comprising:
an operating system having a user interface and being configured to process touch data according to a first protocol;
a software application running on the operating system, the software application providing an application window on the user interface and being configured to process touch data according to a second protocol;
a touch controller configured to send a first touch data corresponding to a touch event to the operating system via a first channel and a second touch data corresponding to the touch event to the software application via a second channel;
the operating system being configured such that, where the first touch data corresponds to the application window of the software application on the user interface, the operating system communicates the first touch data to the software application,
the software application being configured such that, where the first touch data received from the operating system corresponds to the second touch data received from the touch controller, the software application processing the first and/or second touch data according to a second protocol.

2. A system according to claim 1, wherein the operating system being configured such that, where the first touch data does not correspond to the application window on the user interface, the operating system processes the first touch data according to the first protocol.

3. A system according to claim 2, wherein processing the first touch data according to the first protocol comprises identifying and processing touch gestures.

4. A system according to claim 1, the software application being configured such that, where the first touch data received from the operating system does not correspond to the second touch data received from the touch controller, the software application processes the first and/or second touch data according to the first protocol or a another protocol.

5. A system according to claim 1, wherein the first touch data comprises a touch co-ordinate corresponding to a position on the user interface, and wherein the first touch data corresponds to the application window on the user interface when the touch co-ordinate matches the portion of the user interface covered by the application window.

6. A system according to claim 1, wherein the software application processes the first touch data and second touch data according to a second protocol to generate a processed touch output.

7. A system according to claim 6, wherein the second touch data provides touch metadata for the touch event described in the first touch data.

8. A system according to claim 7 wherein the metadata in the second touch data is one or more of the following: device lift up indication, pressure, speed, direction, predictive data, low latency position, shape, type of touching device, orientation of touching device, angle of touching device.

9. A system according to claim 6, wherein the processed touch output comprises one or more of predictive touch output, smoothed touch output, filtered touch output and/or touch output having increased spatial accuracy.

10. A system according to claim 1, wherein the first and/or second channels are logical or physical data connections.

11. A system according to claim 1, wherein the first touch data is a USB HID data and the first channel is a USB HID API channel of the operating system.

12. A system according to claim 1, wherein an interaction area is a sub-portion of an application window displayed by the application on the user interface, and wherein the software application being configured to process the touch data according to the second protocol where the first touch data corresponds to the interaction area.

13. A system according to claim 12, wherein the interaction area comprising user interface elements and wherein the software application being configured to process the touch data according to the first protocol or another protocol where the first touch data corresponds to the user interface elements in the interaction area.

14. A system according to claim 1, wherein the second channel comprising data sent to an operating system port where the software application is listening.

15. A system according to claim 1, wherein the touch controller being configured to receive and process a touch signal from a touch sensing apparatus comprising one of an FTIR, above-surface, p-cap, resistive wire, optical imaging, or acoustic touch systems.

16. A system according to claim 1, wherein the second touch data comprises proprietary features or features that cannot be processed by the operating system's standard protocol alone.

17. A method for processing touch data in a touch system, the touch system comprising:
an operating system having a user interface and being configured to process touch data according to a first protocol;
a software application running on the operating system, the software application providing an application window on the user interface and being configured to process touch data according to a second protocol;
the method comprising the steps of: receiving a first touch data corresponding to a touch event at the operating system via a first channel and a second touch data corresponding to the touch event at the software application via a second channel;
determining if the first touch data corresponds to the application window on the user interface,
where the first touch data corresponds to the application window, communicating the first touch data to the software application,
determining if the first touch data received by the software application corresponds to the second touch data received from the touch controller,
where the first touch data received by the software application corresponds to the second touch data received from the touch controller, processing the first and/or second touch data according to a second protocol.
